(19) United States
(12) Patent Application Publication
(10) Pub. No.: US 2026/0368077 A1
(43) Pub. Date: Nov. 19, 2026

(54) SYSTEM AND METHOD FOR TESTING AN ARTIFICIAL INTELLIGENCE (AI) AND GENERATIVE AI APPLICATION

(71) Applicant: TECH MAHINDRA LIMITED, Maharashtra (IN)

(72) Inventors: Imran Nisar Ahmed PACHAPURI, North Sydney (AU); Rohit Arvind SANT, Maharashtra (IN); Ajinkya Ashokrao SIRSIKAR, Maharashtra (IN)

(21) Appl. No.: 19/648,033

(22) Filed: Apr. 15, 2026

(30) Foreign Application Priority Data
May 16, 2025 (IN) 202521047533

(51) Int. Cl. G06F 11/3698; G06F 9/54; G06F 11/362

(52) U.S. Cl. CPC G06F 11/3698; G06F 9/547; G06F 11/3644

(57) ABSTRACT

The present invention relates to a system (102) for testing the AI and Gen AI applications comprising the user interface (302) configured to enable interaction with the user and facilitate access to the plurality of modules, API's (304), playbooks (308), tools (310), demo module (312), assets, and playgrounds (316). The plurality of API's (304) comprises a functional APIs, plurality of non-functional APIs, and plurality of governance APIs. The plurality of tools (310) selected from the group consisting of test-driven RAG development tool, automated multi-agent system tool, non-functional LLM testing tool, LLM security testing tool, integration and monitoring dashboard, and guardrails, and configured to perform automated RAG evaluation, agentic supervision testing, non-functional LLM testing, and security testing using adversarial prompt generation. The system (102) is configured to evaluate, validate, and test applications using the plurality of tools (310) and API's (304).

### CROSS-REFERENCE TO RELATED APPLICATIONS AND PRIORITY

The present application does not claim priority from any patent application.

### TECHNICAL FIELD

The present invention relates generally to the field of a system and method for testing an artificial intelligence (AI) and generative AI application. Particularly, the present invention involves a system to provide a comprehensive validation and verification solution for AI and GenAI applications. The system provides the accuracy, security, and reliability of AI models throughout the lifecycle, from PoC to Production, and before development, during development, and post-development.

### BACKGROUND OF THE INVENTION

The launch of Generative Artificial Intelligence (AI) has opened immense possibilities for the businesses, enterprises, and individuals across the world. Every day, newer AI models are released, and businesses across the world are using these AI models to build use cases suitable for their respective business requirements. Businesses may develop innovative use cases, however, there is a huge struggle in taking those use cases to production. A traditional application is not fully developed or trained to test the AI application.

Generally, software testing is a complex endeavour that is manually performed by expensive teams of software experts. Recent developments in artificial intelligence (AI) and machine learning (ML) have opened new challenges whereby the AI systems itself have to be tested for reliable outcome. Despite the latest advances in natural language processing, the applicability of testing the transformer-based Large Language Models (LLMs) itself is yet unproven.

Therefore, to overcome the problems associated with the traditional system, there is need for a system and method for testing an artificial intelligence (AI) and generative AI application by helping the enterprises to scale their AI initiatives faster and more responsibly by providing a robust framework for AI application validation.

### OBJECTS OF THE INVENTION

Primary objective of the present invention is to provide a system and a method for testing an artificial intelligence (AI) and generative AI application.

Another objective of the present invention is to verify and tunes the deployed models to ensure that outputs are consistent, explainable, and meet user expectations during the production and post-production stages.

Yet another objective of the present invention is to provide a comprehensive system and pre-built solutions configured to enable enterprises to scale their AI initiatives quickly and responsibly.

Another objective of the present invention is to reduce the risk of errors and biases in AI models by automating the validation and verification processes by using the proposed system.

### SUMMARY OF THE INVENTION

Before the present system is described, it is to be understood that this application is not limited to the particular machine, device, or system, as there can be multiple possible embodiments that are not expressly illustrated in the present disclosures. It is also to be understood that the terminology used in the description is to describe the particular versions or embodiments only, and is not intended to limit the scope of the present application. This summary is provided to introduce aspects related to a system and method for testing an artificial intelligence (AI) and generative AI application, and the aspects are further elaborated below in the detailed description. This summary is not intended to identify essential features of the proposed subject matter nor is it intended for use in determining or limiting the scope of the proposed subject matter.

In an embodiment, the present invention provide a system for testing an artificial intelligence (AI) and generative AI applications, the system comprising a user interface (UI) configured to enable user interaction and facilitate access to a plurality of application programming interfaces (APIs), and a set of testing tools (310), wherein the UI (302) is operatively coupled to a processor and a memory, and wherein the processor is configured to receive a user input data, comprising documents or prompts, via the UI (302), transmit the input data via an API gateway to at least a testing tool (310), wherein each tool from the set of tools (310) communicatively coupled with the APIs (304), executable via the user interface (302), wherein the tools (310) are configured to: chain multiple APIs together and invoke at least an API from plurality of APIs (304) using an endpoint URL on the basis of said input and transmit the user input data to the invoked API (304) via the API gateway, wherein the invoked API (304) is configured to forward the user input data to an embedded or connected LLM/NLP engine for evaluation, receive and compute an evaluation score corresponding to said data; store the computed score in the backend database (306) and return the score to the testing tool (310) so as to visualize said score; and present the computed score, visualizations, and metric explanations to the user via the UI (302); and wherein the APIs (304) are documented using swagger and support chaining with other APIs within a plug-and-play architecture.

In an embodiment the present invention provides the plurality of APIs (304) comprises a) one or more governance APIs selected from the group comprising of a hallucination detection API configured to flag AI-generated content not grounded in source data, a bias and fairness evaluation API configured to detect algorithmic bias across demographic parameters, a personally identifiable information (PII) detection API configured to identify and redact sensitive data, a high assurance processing (HAP) detection API, a prompt drift detection API, and a large language model (LLM) drift detection API, (b) one or more functional APIs selected from the group comprising of chunk relevance, groundedness, response relevance, correctness, BLEU, ROUGE, METEOR, BERTScore, sentence mover similarity, and completeness, (c) one or more non-functional APIs selected from the group comprising of: token count, throughput, latency, robustness, toxicity, social harm, and model drift, (d) one or more security APIs selected from the group comprising of: prompt injection detection, data poisoning detection, sensitive output handling, and custom security prompt design.

In an embodiment, the present disclosure provides that the APIs (304) are implemented as independent micro services, each accessible at an endpoint URL, deployed on containers managed via container orchestration platforms including Docker or Kubernetes.

In still another embodiment, the present disclosure provides that the each API (304) is documented and accessible through a Swagger interface, and programmatically callable via common scripting interfaces including Python's requests library or cURL.

In yet another embodiment, the present disclosure provides that an LLM-based scoring module integrated within the APIs (304), configured to: extract claims from AI-generated responses, compare the claims with retrieved contextual data, generate a hallucination score using binary judgments, and output both metric scores and natural language justifications.

In still another embodiment, the present disclosure provides that the tools (310) are configured to perform tasks comprising (a) test-driven RAG development, comprising automated RAG evaluation, chunking, embedding, and vector database selection; (b) multi-agent system simulation with agentic scoring and tool selection; (c) non-functional load and stress testing with visualized metrics; (d) adversarial and prompt injection testing using security utilities; and (e) visualization and real-time monitoring via dashboards.

In an embodiment, the present disclosure provides that the plug-and-play architecture enables chaining of APIs (304) into user-defined workflows, orchestrated using a code integration application (320).

In an embodiment, the present disclosure provides that a reference playbooks (308) provide step-by-step procedures for validating generative AI applications, stored in the backend database (306) and accessible via the user interface (302).

In an embodiment, the present disclosure provides that a demo module (312) is configured to simulate real-world AI use cases including chatbot testing, insurance processing, and news summarization, using uploaded user data.

In an embodiment, the present disclosure provides that a playgrounds (316) module configured to provide interactive, code-free testing environments that utilize embedded Swagger APIs for prompt testing, security guardrail evaluation, and output validation.

In an embodiment, the present disclosure provides that the testing tools (310) comprise a workflow orchestration engine configured to select, arrange, and execute a sequence of APIs (304) based on a user-defined test plan.

In an embodiment, the present disclosure provides that the plug-and-play architecture enables addition, removal, or reordering of APIs (304) in a validation workflow without requiring code changes to the core system and wherein the processing unit (202) is configured to orchestrate a plurality of metric API's (304) in a plug-and-play architecture using programmatic methods for use case-specific validation workflows.

In an embodiment, the present disclosure provides that the evaluation scores are generated by the large language model (LLM) using a prompt-based evaluation steps and a QAG (Quality Assurance Group) scorer.

In an embodiment, the present disclosure provides that the APIs (304), when invoked via the testing tools (310), are configured to evaluate AI and GenAI outputs for one or more quality and risk parameters comprising hallucination, bias, relevance, groundedness, correctness, latency, security vulnerabilities, and compliance, and to return corresponding evaluation scores or annotations that are stored in the backend database (306) and rendered to the user interface (302) or a monitoring dashboard for interpretation and analysis.

In yet another embodiment, the present disclosure provides a method (600) for testing and validating Artificial Intelligence (AI) and Generative AI (GenAI) applications using a system (102). The method comprising steps o receiving, via a user interface (UI) (302), a user input comprising documents or prompts along with test configuration parameters; transmitting the received user input to a testing tool (310) via an API gateway, invoking, by the testing tool (310), at least one application programming interface (API) (304) from a plurality of APIs (304), by issuing a structured request to an endpoint URL via the API gateway, chaining, by the testing tool (310), multiple APIs (304) in a sequential or composite workflow according to a plug-and-play architecture, wherein the output of one API (304) is used as input or context for another, forwarding the user input to an embedded or connected large language model (LLM) or natural language processing (NLP) engine for evaluation via the invoked API (304), computing, by the LLM/NLP engine, an evaluation score associated with the user input, including but not limited to bias, correctness, groundedness, or security metrics; storing the computed score and associated metadata in a backend database (306), retrieving, by the testing tool (310), the computed score and any associated visualizations or metric explanations; presenting the results, including the evaluation score and visualizations, to the user via the UI (302), and wherein the APIs (304) are documented using swagger and support chaining with other APIs within a plug-and-play architecture.

### BRIEF DESCRIPTION OF DRAWING

The foregoing summary, as well as the following detailed description of embodiments, is better understood when read in conjunction with the appended drawings. For the purpose of illustrating the disclosure, there is shown in the present document example constructions of the disclosure, however, the disclosure is not limited to the specific methods and device disclosed in the document and the drawing. The detailed description is described with reference to the following accompanying figures.

FIG. 1: illustrates a network implementation of a system, in accordance with an embodiment of the present subject matter.

FIG. 2: illustrates the block diagram of the system for testing an artificial intelligence (AI) and generative AI application, in accordance with an embodiment of the present subject matter.

FIG. 3: illustrates the architecture of the system for testing an AI and generative AI application, in accordance with an embodiment of the present subject matter.

FIG. 4: illustrates a flow diagram showing the selection of API, in accordance with an embodiment of the present subject matter.

FIG. 5: illustrates a block diagram showing the plurality of phases of the system to test the development life cycles of AI and Gen AI applications.

FIG. 6: illustrates a flow chart performing a method for testing the AI and generative AI application, in accordance with an embodiment of the present subject matter.

The figures depict various embodiments of the present disclosure for purposes of illustration only. One skilled in the art will readily recognize from the following discussion that alternative embodiments of the structures illustrated herein may be employed without departing from the principles of the disclosure described herein.

### DETAILED DESCRIPTION OF THE INVENTION

Some embodiments of this disclosure, illustrating all its features, will now be discussed in detail. The words “comprising”, “having”, and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any devices and methods similar or equivalent to those described herein can be used in the practice or testing of embodiments of the present disclosure, the exemplary, devices and methods are now described. The disclosed embodiments are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

Following is a list of elements and reference numerals used to explain various embodiments of the present subject matter.

| Reference Numeral | Element Description |
|---|---|
| 100 | Network implementation of a system |
| 102 | System |
| 106 | Network |
| 202 | Processing Unit |
| 206 | Storage Device |
| 302 | User interface |
| 304 | Application programming interface (API) |
| 306 | Database |
| 308 | Playbook |
| 310 | Tool |
| 312 | Demo module |
| 314 | Asset |
| 316 | Playground |
| 318 | Development Integration |
| 320 | Developers |
| 322 | Production Integration |
| 600 | Method |

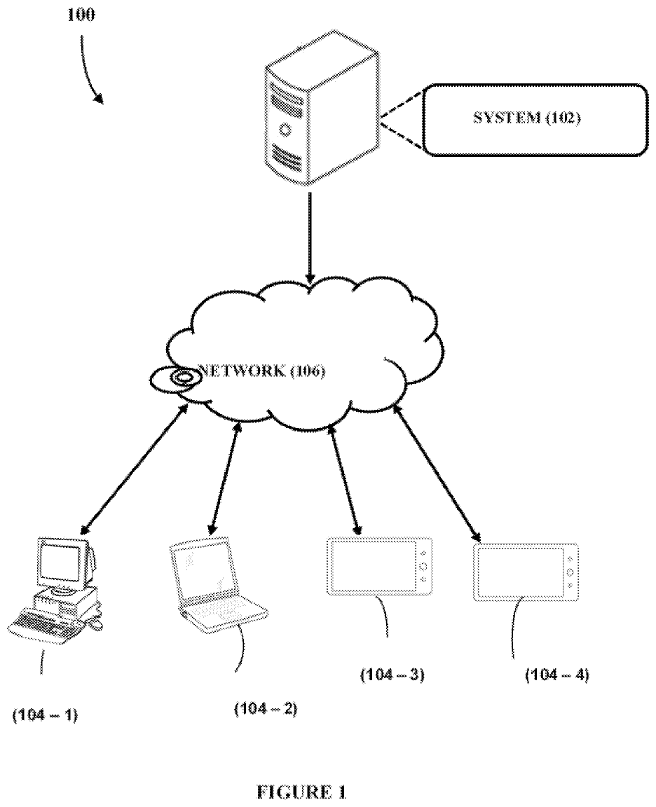

Referring now to FIG. 1, a network implementation (100) of a system (102) is illustrated. The system (102) is being implemented on a server, it can be understood that it may also operate on various computing systems, such as laptops, desktops, notebooks, workstations, mainframes, or within cloud-based environments. Multiple users can access the system (102) through various user devices (104-1) (104-2) (104-3) (104-4), collectively referred to as users or stakeholders, which may include IoT devices, IoT gateways, portable computers, personal digital assistants, handheld devices, and workstations, all communicatively coupled to the system (102) through a network (106). This network (106) may be wireless, wired, or a combination of both, and can take the form of intranets, local area networks (LAN), wide area networks (WAN), or the internet, utilizing various protocols such as HTTP, HTTPS, and TCP/IP. Furthermore, the network (106) may comprise a range of devices, including routers, bridges, servers, and storage devices.

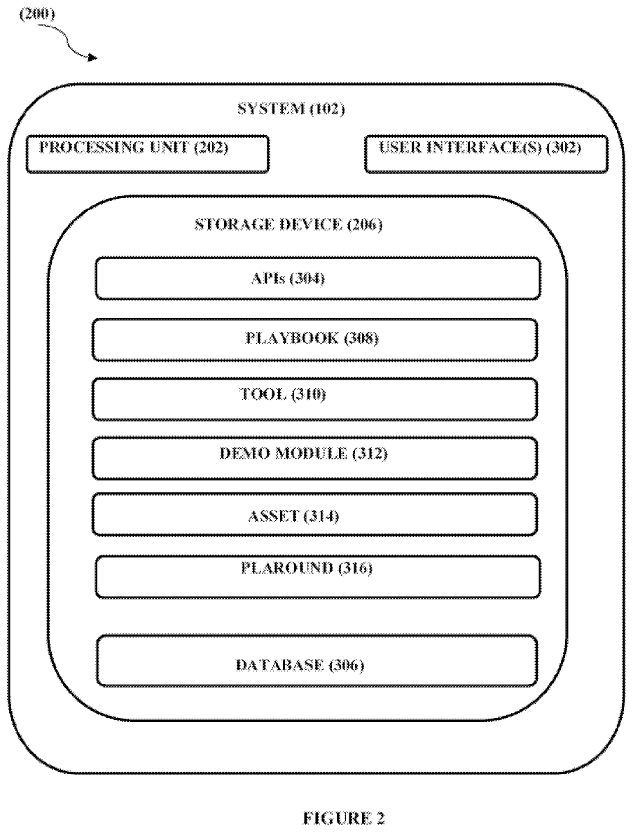

In accordance with an embodiment illustrated in FIG. 2, an architecture (200) of the system (102) for testing an artificial intelligence (AI) and generative AI application is illustrated. The system (102) includes at least one processing circuitry or processing unit (202), an user interface (302), and a storage device (206). The processing unit (202), which may consist of microprocessors, microcontrollers, or digital signal processors, is responsible for executing computer-readable instructions stored in the storage device (206). The user interface (302) facilitates interaction with users and communication with other computing devices, supporting multiple network types and protocols. The storage device (206) encompasses various computer-readable media, including volatile and non-volatile memory, and contains a plurality of modules, API's (304), playbook, tools (310), asset (314), playground (316), demo module (312) and database (306). The plurality of modules comprises routines and programs that execute specific tasks, and the database (306) serves as a storage space for processed, received, and generated data, including data associated with the invention. The system (102) is builds on container technologies so the system (102) is portable on any cloud platform. The system (102) comprises plurality of components and modules, including Application Programming Interface (APIs) (304), playbook (308), tool (310), demo module (312), Asset (314), playground (316), and Database (306).

An user interface (UI) (302) is the first page of the system (102) for accessing the different type of module of the system (102). The UI may be accessed by the users to explore the capabilities of the system (102) as well as interact with system (102) through prompts. The system (102) comprises a plurality of Application Programming Interface (APIs). The API's (304) may be directly called into the application whenever the user want to test. The plurality of APIs are well defined with the server names and the endpoints with the payload definition. The system (102) call these APIs easily for testing and for observability of any type of application testing. The API's (304) integrates and connects with various tools (310) and platforms to provide a seamless validation experience to the user.

The system (102) further comprises a plurality of tools (310). These tools (310) are used by the user for testing any kind of AI and Gen AI applications. These tools (310) take input as a text or document. The user may select various parameters of the tools (310) (depending on the tool and its purpose), and the tools (310) will let the user to execute the test. The system (102) further comprises Reference Playbook (308). The playbook (308) are PDF documents which are accessed by the users. The playbook (308) shows the stepwise working of using of plurality of module, tools (310) and other features of the system (102).

The demo modules (312) enable user to enter their text or documents. The demo module (312) shows the system (102) and its various components and modules will work in real world. Playground Apps (316) are experimental apps. The users can enter their text or documents and can see how the output will get generated. In an embodiment, the users may upload and delete asset (314) documents through the UI.

In an embodiment, the system (102) uses the database (306) in the backend to store various types of information. In an embodiment, the Database (306) may be also referred to as a backend services. All information, such as metrics data, prompt library data, is saved in the database (306).

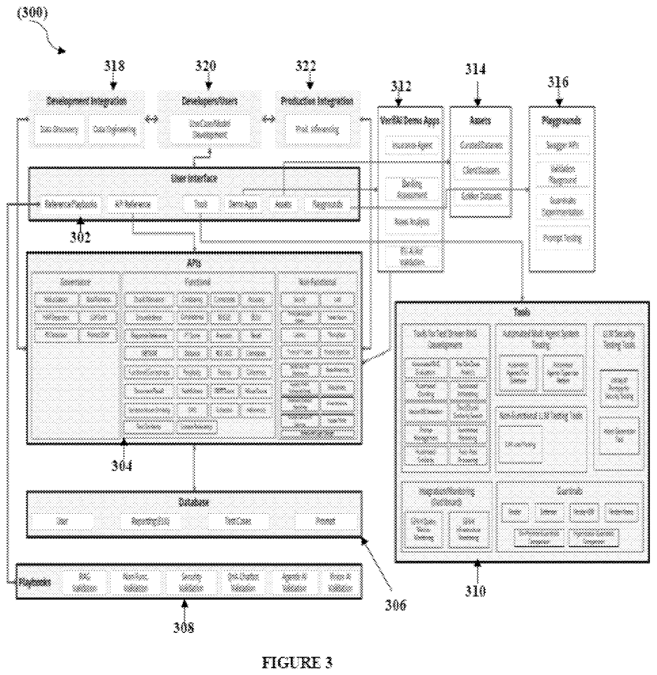

In another embodiment, a FIG. 3 illustrates the architecture of the system (102) for testing an AI and generative AI application. The architecture comprises a user interface (UI) (302) for the users to interact with the system (102). This UI may be used by different users depending on their use. The system (102) provides ability to all the users involved in the AI use case implementation end-to-end. Through this UI, the users may access the APIs, Reference Playbooks (308), Tools (310), Demo module (312), Assets (314) and Playgrounds (316).

The system (102) is provided with a plurality of application programming interfaces (APIs) to be built on a micro-services architecture/framework. The API integrates with various tools (310) and platforms to provide a validation experience. The API includes Metric API's (304) such as a functional, a non-functional, and a governance APIs for evaluating quality aspects like bias and hallucination and to perform support tasks such as adversarial attack detection, and load testing. The plurality of APIs allows users to create their own tools (310) and extend the capability to meet their business or regulatory requirements. A set of quality metrics has to be established to test Gen AI application. The quality metrics include Bias, Hallucination and others. The system (102) comprises a plurality of metrics in the form of Metrics APIs. In an embodiment, the system (102) provides 30 APIs for measuring various quality metrics. In addition to the Metrics APIs, there are also Functional APIs available to carry out certain functional activities such as detecting adversarial attacks, generating attacks, generating load test and few other APIs. The system (102) contains 50+ APIs across Metrics APIs and Functional APIs. Therefore, the system (102) comprises a plurality of tools (310) that are powered by these APIs.

The plurality of APIs are accessed via Swagger documentation. In an embodiment, the plurality of API's (304) are also accessed via endpoints, which allow easy integration with any application and environment.

In an embodiment, the Governance API's comprises a plurality of quality metrics such as hallucination, Bias/fairness, Hourly Analysis Program (HAP) detection, large language models (LLM) Drift, Personally Identifiable Information (PII) Detection, and Prompt Drift. This metrics may be selected by the user to test the AI and Gen AI application.

In an embodiment, the functional API's comprises a plurality of quality metrics such as a chunk relevance, consistency, correctness, accuracy, groundedness, completeness, Recall-Oriented Understudy for Gisting Evaluation (ROGUE), Bilingual Evaluation Understudy (BELU), response relevance, F1 score, precision, recall, Metric for Evaluation of Translation with Explicit Ordering (METEOR), distance, Receiver Operating Characteristic (ROC), receiver operating characteristic, Area Under the Curve (AUC), correlation, functional correctness, perplexity, fluency, coherence, document recall, faithfulness, BERTScore, MoverScore, Sentence Mover similarity, Software Agents for Retrieval of Information (SARI), cohesion, Adherance, Text similarity, and context relevancy.

In an embodiment, the plurality of quality metrics explained further in detail.

In an embodiment, the system provides functionality to detect bias in LLM-generated content using judge LLM. The bias metric takes a string of query (optional) and generated response as an input to determine whether generated response contains gender, racial/ethnic, geographical or political bias. It uses a judge LLM to extract all opinions found in the generated response, before using the same LLM to classify whether each opinion is biased or not and produces score between 0 and 1. Metric score 1 denotes the highest bias in response, 0 denotes no bias.

In an embodiment, the TextSimilarity using the Cosine Similarity metric measures similarity between two input texts by giving a similarity between 0 to 1 score as output. This metrics measure the similarity between two LLM outputs received from different models or same model in different call.

In an embodiment, the cohesion is a measure of the semantic and logical consistency of text. It evaluates how well various parts of the text work together to form a coherent whole. This metric considers three main aspects: 1. Lexical Cohesion: This involves the use of vocabulary. A higher lexical cohesion score indicates a rich and varied vocabulary where words are used effectively to enhance meaning. 2. Grammatical Cohesion: This includes the use of grammatical structures such as pronouns, conjunctions, and other parts of speech that help in maintaining the flow and logical connections within the text. 3. Readability Cohesion: This is assessed using readability scores like the Flesch Reading Ease score. It measures how easy the text is to read and understand. By combining these three aspects, the cohesion score provides a comprehensive evaluation of the text's quality in terms of its coherence and readability

LLM & Prompt drift: This metric detects distribution drift in LLM-generated responses (LLM drift) and input prompt (prompt drift) over time. It takes a list of prompts and generated responses in the current production data and analyses them to the list of prompts and generated responses in reference data. The reference dataset serves as a benchmark for comparing prompts and responses to detect prompt and LLM drifts, respectively. It also uses token count, sentiment, response-question similarity, neutrality etc. to justify drift in current and reference dataset. Drift score is computed by comparing current data against reference data using Z-test p-value stattest. The drift is detected when p_value (score)<threshold (set to 0.05)

The system provides functionality to detect hallucination in LLM-generated responses using a judge LLM. The hallucination metric takes string of input query, response and a list of chunks similar to the query (context coming from the retriever) to determine whether the generated response from LLM is factually correct information by comparing the actual output to the provided context. It uses a judge LLM to determine whether there are any contradictions to the actual output for each context in retriever. The degree of hallucination is measured by the degree of which the contexts is disagreed upon to produce a score ranging between 0 and 1. Metric score 1 denotes the highest hallucination in response, 0 denotes no hallucination.

In an embodiment, the HAP Detection module provides functionality to detect Hateful, abusive, and profane (HAP) content in LLM-generated content using a judge LLM. HAP detection metric takes string of query (optional) and generated response as an input to determine toxicness in LLM outputs, considering rubrics like personal attacks, mockery, hate, dismissive statements, threats or intimidation etc. It uses a judge LLM to extract all opinions found in the generated response, before using the same LLM to classify whether each opinion is toxic or not and produces a score ranging between 0 and 1. Metric score 1 denotes highest toxicity in response, 0 denotes no toxicity.

Answer Relevancy: This endpoint validates LLM LLM-generated response against provided reference context, and returns the answer relevancy Score using the Deepeval library.

Rouge: This endpoint validates the ROUGE (Recall-Oriented Understudy for Gisting Evaluation) score in LLM-generated content using Deep Eval, which evaluates the summarization tasks done by an LLM.

Context Precision: This endpoint validates LLM LLM-generated response against provided reference context, and returns the context precision Score using the Deepeval library using the expected output as a reference.

Context Recall: This endpoint validates LLM generated response against provided reference context, and returns the context recall Score using the Deepeval library

The SARI (System output Against References and the Input sentence) score evaluates how well a text simplification system performs in terms of adding, deleting, and keeping words appropriately. The score is computed by comparing the system's output with reference sentences provided by human annotators.

In an embodiment, the Perplexity is a measurement that reflects how well a model can predict the next word based on the preceding context. The perplexity score is calculated using the GPT-2 model tokenizer, a state-of-the-art transformer-based language model developed by OpenAI, the GPT-2 tokenizer provided by the Hugging Face transformer library is open source.

Consistency: This module refers to the alignment and coherence of the generated text with the retrieved information.

Faithfulness module provides functionality to detect faithfulness in LLM-generated content using judge LLM. The faithfulness metric takes string of input query, response and list of chunks similar to query (context coming from retriever) to measures the quality of RAG pipeline's generator by evaluating whether the generated output factually aligns with the contents of retrieval context. It is more concerned with contradictions between the generated output and retrieval context in RAG pipelines, rather than hallucination in the actual LLM itself. It uses a judge LLM to extract all claims made in the generated output, before using the same LLM to classify whether each claim is truthful based on the facts presented in the retrieval context. A claim is considered truthful if it does not contradict any facts presented in the retrieval context. It produces score ranging between 0 and 1, metric score 1 denotes highest faithfulness in response, 0 denotes no faithfulness.

BERT Score module provides functionality to validate generated text using BERT model by comparing against reference text. The BERTScore metric takes input string of generated text (a current input) and reference text (a benchmark input) to perform similarity calculations using contextualized token embeddings and provide insights into the semantic similarity between current and reference text. It leverages the pre-trained contextual embeddings from BERT and matches words in candidate and reference sentences by using text similarity. It produces bert precision, recall and F1 score ranging between 0 and 1, A higher metric score indicates a greater degree of semantic overlap between the current and the reference text.

Completeness module provides functionality to detect completeness (conversation completeness) in LLM-generated response using judge LLM. The completeness metric is a conversational metric that takes string of input query and generated response to determine whether LLM is able to complete an end-to-end conversation by satisfying user needs throughout a conversation. It uses a judge LLM to extract a list of high level user intentions found in the input query, before using the same LLM to determine whether each intention was met and/or satisfied throughout the conversation in the generated response. A conversation is considered fruitful if user intentions are satisfied by the LLM service. It produces score ranging between 0 and 1, Metric score 1 denotes highest completeness in response, 0 denotes no completeness.

Knowledge Retention module provides functionality to detect knowledge retention in LLM-generated response using judge LLM during a conversation. The knowledge retention metric is a conversational metric that takes list of dictionaries containing queries and their respective generated responses made during a conversation to determine whether LLM is able to retain factual information presented throughout a conversation. It uses a judge LLM to extract knowledge gained throughout messages, before using the same LLM to determine whether each corresponding LLM responses indicates an inability to recall said knowledge. It produces score ranging between 0 and 1, Metric score 1 denotes perfect knowledge retention in the conversation, 0 denotes no knowledge retention.

Answer Correctness: This endpoint measures answer correctness of the LLM application using Deepeval library by comparing an LLM's actual output with the ground truth

F1 endpoint measures F1 score of the LLM application using Scikit Learn library. The F1 score is a measure used to evaluate the accuracy of a classification use case such as sentiment analysis, intent detection in dialog systems, others. The input consists of string as a list representation of 1s and 0s (the labels of the classification tasks).

PII module provides the functionality to detect Personally Identifiable Information (PII) in given input string. The PII detection metric takes string of input text to determine whether it contains PII entities like credit/debit card number, US Social Security Number (SSN), crypto wallet number, IBAN Code, UUID, IPs, URLs, e-mail addresses, passport details, bank number, medical license number, location etc. It leverages custom models crafted with named entity recognition models like spaCy, flair and transformers libraries, for precise detection of private data to produce score between 0 and 1. Scanner score 1 denotes highest risk of PII leaking, 0 denotes no risk at all.

Bilingual Evaluation Understudy: This endpoint validates the BLEU (Bilingual Evaluation Understudy) score in LLM-generated content using Deep Eval. It is used for evaluating the quality of text which has been machine-translated from one natural language to another

METEOR module provides functionality to detect similarity between two text inputs. The METEOR (Metric for Evaluation of Translation with Explicit ordering) score is a metric used to evaluate the quality of text, particularly in the context of machine translation and text similarity. It is designed to address some of the limitations of other metrics like BLEU. Here are some advantages of using the METEOR score for matching text similarity: Precision and Recall: METEOR considers both precision and recall, providing a more balanced evaluation compared to metrics that focus solely on precision. Synonymy and Stemming: METEOR incorporates synonymy and stemming, allowing it to recognize words that are different but have similar meanings or roots. This makes it more robust in evaluating semantic similarity. Alignment: METEOR aligns words and phrases between the candidate and reference texts, which helps in capturing the similarity more accurately. Fragmentation Penalty: It includes a fragmentation penalty to account for the disjointedness of the matched words, encouraging more fluent and coherent matches. Flexibility: METEOR can be adapted to different languages and domains by adjusting its parameters and resources like synonym dictionaries. The matrics gives score between 0-1 where 1 is highly similar and 0 is not similar.

Earth Mover Distance is a measure used in various fields, including Natural Language Processing (NLP), to quantify the distance between two probability distributions. In the context of NLP, it can be used to compare the similarity between two sentences by considering the cost of transforming one sentence into another.

ROC AUC module provides functionality to detect similarity between two text inputs. The AUC can be calculated using the trapezoidal rule to find the area under the ROC curve. The matrics gives score between 0-1 where 1 is highly similar and 0 is not similar.

Context Relevancy endpoint validates the contextual relevancy metric measures the quality of the RAG pipeline's retriever by evaluating the overall relevance of the information presented in your retrieval context for a given input.

In an embodiment, the Non-functional API's comprises plurality of quality metrics such as a security, load, Time per output token, token count, latency, throughput, time to 1^{st} token, prompt injection, sensitive info disclosure, data poisoning, supply chain vulnerabilities, robustness, insecure output handling, overreliance, model denial of service, model theft, and insecure plugin design. In an embodiment, the prompt modules are illustrated further.

In an embodiment, an Attack Prompt Generation module provides an endpoint for generating attack prompts based on user-provided domain context and attack type. It accepts user input and generates text prompts for the specified attack category.

In an embodiment, an Attack Prompt Enhancement module provides an endpoint for enhancing attack prompts based on user-provided generated prompts and paste completions. It accepts user input and enhances the provided prompts.

In an embodiment, an Attack Prompt Search module provides an endpoint for searching prompts based on user-provided domain, language, and type. It accepts user input and retrieves text prompts for the specified criteria.

In an embodiment, the plurality of APIs (304) provides a way to create new and innovative plurality of tools (310) towards testing of Gen AI applications by connecting the plurality of tools (310) and Gen AI application together. This is one of the new capabilities of the system (102). The plurality of APIs may be built on a consistent framework, and API's documentation is available through the user interface (302). The plurality of API's (304) gives the scoring (for e.g., hallucination score, Bias score, and like more) as well as explanation. The explanation fulfils an important aspect of the responsible AI requirement.

The system (102) employs a layered API architecture, primarily built using Python and JavaScript. At the core, the system (102) leverages a combination of open-source Python libraries and publicly available NLP tools/models. These tools (310) are integrated to perform various validation tasks on generative AI systems. The specific implementation details of each layer depend on the selected tools (310) and the specific validation metrics being implemented.

In an embodiment, the system (102) uses API gateway. The API gateway acts as a central hub, reducing the complexity of managing and invoking the plurality of Metric API's (304). The API gateway provides routing, load balancing, and other features that simplify the integration of the Metric API's (304) into the system (102).

The system (102) mainly uses LLM as a decision module to give a score and reason to the input metric for the metrics selected by the user. The LLM generates a series of evaluation steps using original evaluation criteria. As per one example, for evaluating LLM output for bias, involves constructing a prompt to generate evaluation steps. The evaluation steps contain the criteria and text to be evaluated. The LLM leverages the high reasoning capabilities of a Quality Assurance Group (QAG) scorer to reliably evaluate LLM outputs. The system (102) extracts all claims made in the generated output. For each claim, it check whether it agrees or contradicts with each individual node in the retrieval context by asking close ended questions in QAG scorer. Answers to each checks are confined to either a ‘yes’, ‘no’, or ‘idk’. The ‘idk’ state represents the edge case where the retrieval context does not contain relevant information to give a yes/no answer. LLM then adds up the total number of truthful claims (‘yes’ and ‘idk’) and divide it by the total number of claims made, to compute a final metric score.

The chaining or stitching of the plurality of individual metric API's (304) within the system (102) is driven entirely by the specific use case. The system (102) uses a plug-and-play architecture whereby any components can be swapped with alternative components to meet user requirements. As per user requirement, the necessary API calls are orchestrated programmatically, typically using tools (310) like cURL or Python's requests library. The exact sequence and logic for chaining these API's (304) are custom-built for each scenario, with code examples available in the system's code integration app to guide developers (320). This approach provides flexibility to adapt to diverse analytical needs.

In an embodiment, the system (102) comprises a plurality of tools (310). The plurality of tools (310) comprises a test-driven Retrieval Augment Generation (RAG) development tool, an automated multi-agent system tool, a Non-functional Large Language model (LLM) testing tool, an LLM security tool, Integration/Monitoring (Dashboard), and Guardrails.

In an embodiment, the test-driven (RAG) development tool further comprises a plurality of sub tools, including Automated RAG evaluation, Pre-Dev data analytics, Automated chunking, Automated embedding, Vector DB selection, Doc (Chunk) Similarity Search, Prompt Management, Automated Re-ranking, Automated Similarity, and Auto Post processing. The Test Driven RAG Development tools are configured for end-to-end testing of the RAG Applications. These tools are designed in the form of a sequential chain. Therefore, the output of one tool is the input to the next tool. These tools give various outputs such as a golden dataset, chunking strategy, embedding strategy, Vector DB selection and a few other functionalities.

In an embodiment, the Automated RAG Evaluation (QnA Generator) module integrates Apache MSK kafka with automated RAG evaluation generator engine. A mid-sized broker is used to enhance the efficiency, scalability, and robustness of synthetic data generation with automated RAG evaluation. A message is sent to kafka topic ‘verifai-AutoRagEvaluation-request-queue’ with input passed to this flask API. Automated RAG evaluation generator pipeline consumes this message and provides a functionality to generate synthetic data using generator and critic LLMs. Generated test set contains question, context, ground truth, evolution type, source file name where context was referred from. Documents are loaded using langchain-based document loader and are segmented using standard chunking techniques. The process of generating good test cases is iterative. The generator LLM model starts by receiving a chunk of text from loaded documents and formulates a potential test case (usually in the form of a question).

The evolution type for generating a question (simple, reasoning, multi-context, concretizing, constrained, comparative, hypothetical etc.) is determined by the distributions setting. The critic LLM model receives the generated question and assesses its quality considering factors like relevance, clarity, difficulty and provides feedback to the generator, suggesting improvements to the question. This process of generation, evaluation, and refinement repeats. The generator takes the critic's feedback into account and tries to generate an improved version of the test case. Successful processing of a document gives question, baseline response (ground truth), contexts, evolution type, hallucination metric score, reference file name. A kafka message with status (Processed/Failed) is sent from backend python code to this flask API with topic ‘verifai-AutoRagEvaluation-response-queue’. Further human evaluation needed to ensure generated test content is matching business' expectations. This pipeline involves a complex, iterative process that may take a significant amount of time.

In an embodiment, the Automated Chunking module integrates Apache MSK kafka with automated chunking pipeline. A mid-sized broker is used to enhance the efficiency, scalability, and robustness of the chunking pipeline in the backend. A message is sent to kafka topic ‘verifai-AutomatedChunking-request-queue’ with input passed to this Flask API. Automated chunking pipeline in the backend consumes this message and uses the provided input for generating and evaluating document chunks optimized for Retrieval Augmented Generation (RAG). The Langchain-based loaders ingest source documents, which are then segmented into chunks using established chunking algorithms. The chunk quality is evaluated using NLP models to assess perplexity (predictability of text), cohesion (internal coherence), context loss (information loss across chunk boundaries), readability, and ROUGE-L score (overlap with reference text). The lower perplexity and context loss, and higher cohesion, readability, & ROUGE-L scores indicate better chunk quality. A synthetic evaluation dataset is created, considering set of chunks as contexts, by using a generator and critic large language models (LLMs).

The RAG pipeline's performance is then evaluated on this dataset, yielding scores for average faithfulness, context relevance, and answer relevance. These scores provide a principled method for assessing the suitability of the generated chunks for use in a production RAG system. A kafka message with status (Processed/Failed) is sent from backend python code to this flask API with topic ‘verifai-AutomatedChunking-response-queue’. This pipeline involves a complex, iterative process that may take a significant amount of time.

In an embodiment, the Automated Embedding module integrates Apache MSK kafka with the automated embedding pipeline. A mid-sized broker is used to enhance the efficiency, scalability, and robustness of embedding pipeline in the backend. A message is sent to kafka topic main-queue-embedding-consuming with input passed to this flask API. Automated embedding pipeline in the backend consumes this message and uses provided input for generating and evaluating document embedding optimized for Retrieval Augmented Generation (RAG). embedding technique is evaluated using contextual loss latency and memory used and suggest best suited metrics for dataset

In an embodiment, the Automated Vector DB enhances the retriever of a RAG pipeline by employing several advanced techniques to improve selection of vectordb, we evaluate vector db based on contextual loss, query time, retrieval accuracy, memory used and suggest best suited vectordb for dataset

In an embodiment, the Automated Similarity module enhances the retriever of a RAG pipeline by employing several advanced techniques to improve selection of similarity we measure similarity score based on euclidean distance, cosine distance, meteor score and provide best similarity measure suited for dataset

In an embodiment, the Automated Reranking module integrates Apache MSK kafka with automated reranking pipeline. A mid-sized broker is used to enhance the efficiency, scalability, and robustness of retriever validation pipeline in the backend. A message is sent to kafka topic ‘verifai-AutomatedReranking-request-queue’ with input passed to this flask API. Automated reranking pipeline in the backend consumes this message and uses provided input for analyzing retriever quality of RAG pipeline. This pipeline employs a two-stage retrieval system for document ranking to optimize retrieval accuracy. Document ID and reranking model name are input, fetching corresponding chunk metadata from an Elasticsearch (ELK) index. These chunks and the query are embedded using Google Gemini VertexAI, generating vector representations.

A first-stage retrieval data was taken from automated-similarity pipeline, ranking chunks based on cosine similarity computed from the embeddings. Subsequently, a reranking stage refines these results using various models. Cross-encoder transformer models (DistilRoberta, Electra, MiniLM, Roberta, TinyBERT) take the query and each retrieved chunk as input, producing a relevance score (0-1) through attention mechanisms comparing the query and individual chunk. Additionally, BM25, a bag-of-words retrieval function considering term frequency and document length, that ranks a set of documents based on the query terms appearing in each document, regardless of their proximity within the document, effectively ranks documents based on query term occurrence and rarity across the corpus. FlashRank models (MultiBERT, T5-Flan) are state-of-the-art cross-encoders-provide reranking relevance scores. Finally, performance is evaluated by comparing the top-k chunks from this reranked list against the top-k results obtained from a FAISS Flat index (ground truth, offering highest accuracy), calculating metrics such as recall@k and F1@k to measure the effectiveness of the retrieval pipeline. A kafka message with status (Processed/Failed) is sent from backend python code to this flask API with topic ‘verifai-AutomatedReranking-response-queue’.

In an embodiment, the Automated RAG Evaluation (Validator) module also provides functionality to validate performance of RAG system using judge LLM models. Ground truth generated by either generator/critic LLM models or formulated by SME are used as a basis to compare actual output received of RAG system. Scores are produced with metrics like faithfulness, answer correctness, answer relevance, context relevance using a judge LLM.

In an embodiment, the Automated Post-processing module enhances the retriever of a RAG pipeline by employing several advanced techniques to improve query effectiveness and context. The pipeline accepts a document ID (following successful automated reranking), a query transformation method (e.g., query rewriting, step-back prompting, query decomposition, query optimization), and context compression techniques (utilizing LangChain based LLMChainExtractor, LLMLingua, and LLMChainFilter). Leveraging custom prompts and a Large Language Model (LLM), the module processes the input document and generates enhanced user query and a compressed, summarized retriever. The process provides metrics including the context length before and after compression, and the resulting compression ratio. Furthermore, KeyBERT, employing Maximal Marginal Relevance (MMR), extracts unique keywords to enrich the chunk metadata, improving overall context understanding and retrieval.

In an embodiment, the automated multi-agent system tool further comprises a plurality of sub-tools, including automated agentic tool selection and automated agentic supervisor pattern. The automated multi-Agent system's tool allows users to test agentic AI applications. The users may test to see how the Tool Selection and Supervisory Agent Selection work. This tool gives quality metrics output such as Trajectory score and Agentic Responses, and like more.

In an embodiment, the Tool Correctness metrics offers a method for evaluating the accuracy of an agent's tool selection and usage. The tool correctness metric is an agentic LLM metric that analyzes the alignment between an agent's actions and its intended behaviour. Given an input query (string), the agent's generated response (string), a list of tools the agent actually used (list of strings), and a list of tools it should have used (list of strings), the metric quantifies the agent's tool-calling precision. It achieves this by directly comparing the actual tools employed against the expected tools. A score of 1 indicates that every tool utilized by LLM agent were called correctly according to the list of expected tools, while a score of 0 signifies that none of the tools called were called correctly. This metric provides a robust assessment of the agent's ability to accurately select and employ the appropriate tools based on the given task and context, offering a granular understanding of its tool usage accuracy.

In an embodiment, the Topic Adherence using Ragas metric measures topic adherence score for the Human message and AI response.

In an embodiment, the Goal Accuracy metric illustrated further. The agent_goal_accuracy using Ragas metric measures topic adherence score for the Human message and AI response.

In an embodiment, the Trajectory Evaluation provides functionality to assess the overall effectiveness of an agent's actions and their resulting outcomes. The agent evaluation metric is an agentic LLM metric that takes input query (string), response (string), and a detailed record of the agent's actions (nested list) to analyze agent's performance by evaluating the appropriateness of each action taken within the sequence. A langchain based TrajectoryEvalChain is used with judge LLM that evaluates agents by reasoning about the sequence of actions taken and their outcomes. This evaluation leverages a Langchain-based TrajectoryEvalChain, which utilizes a specialized judge LLM to reason systematically about the agent's actions and their impact. The resulting trajectory evaluation score is a normalized value between 0 and 1. A score of 1 signifies optimal efficiency and effectiveness in the agent's actions, while a score of 0 indicates the least effective utilization of actions.

In an embodiment, the Statistics Management may meticulously provide functionality to track the execution of agentic AI systems, capturing detailed information about each step taken by sub-agents or tools. It is an agentic LLM metric that takes input (string), and a detailed record of the tools to perform agent's actions (list with tool name and description) to analyze agent's performance. The process uses Langchain based custom callback function and involves iterative steps of information gathering. The module captures and stores the details of each step, such as input provided, associated logs, LLM interaction (if any), observations, generated output, input and output token counts, start and end timestamps, latency, and memory consumption, providing a comprehensive audit trail of the agent's reasoning and interactions. The data is structured as a list of dictionaries, each representing a single action or step within the agent's workflow. This comprehensive logging enables a thorough analysis of the agent's behaviour, resource utilization, and performance bottlenecks, facilitating debugging, optimization, and understanding of the agent's decision-making process.

Automated Agentic Tool Selection provides an automated pipeline for generating and evaluating Langchain-based agents using default tools. It accepts user input in the form of a natural language task, the name of a language model (LLM) to power agent reasoning, and leverages Langchain's default toolset, including options like Search, Wikipedia, YouTube Search, DuckDuckGo Search, StackExchange, Arxiv, llm-math, PubMed, PythonREPLTool, and text/JSON file readers. Based on the user's input, the module intelligently selects and loads the appropriate tool(s) to create an agent capable of performing the requested task. The module's output is comprehensive, providing detailed tool specifications (names and descriptions), a trajectory report documenting the agent's execution path (including timestamps, latencies, observation logs, memory usage, and token counts), and a validation metrics report powered by DeepEval. This report offers key performance indicators such as knowledge retention, task completeness, conversation relevance, and answer relevance, each scored on a scale of 0-1, where 1 signifies optimal performance and 0 signifies poor tool utilization. This module offers users a granular view into the agent's decision-making process and allows them to benchmark the performance of different agent-tool configurations, facilitating the development and selection of effective LLM-powered agents for diverse applications.

Automated Agentic Supervisor Pattern provides an automated pipeline for generating and evaluating Langchain-based supervisor agents. It accepts user input in the form of a natural language task, the name of a language model (LLM) to power agent reasoning, and leverages subagents developed in the system's automated agentic tool selection module. Based on the user's input, the module intelligently uses subagents to perform the requested task. The module's output is comprehensive, providing a trajectory report documenting the supervisor agent's execution path (including timestamps, latencies, observation logs, memory usage, and token counts), and a validation metrics report powered by DeepEval. This report offers key performance indicators such as knowledge retention, task completeness, conversation relevance, and answer relevance, each scored on a scale of 0-1, where 1 signifies optimal performance and 0 signifies poor tool utilization. This module offers users a granular view into the supervisor agent's decision-making process and allows them to benchmark the performance of different agent-tool configurations, facilitating the development and selection of effective LLM-powered agents for diverse applications.

In an embodiment, the Non-functional LLM testing tool includes an LLM load testing tool. The Non-Functional LLM Testing Tools are configured to perform the load testing. This tool allows users to configure the load testing, and the tool generates the load according to the configuration and displays a performance graph.

In an embodiment, the LLM security testing tool further comprises sub-tools including a library of prompts for security testing and an attack generation tool. The LLM security testing tools allow users to generate adversarial prompts that may be targeted towards the Gen AI application.

In an embodiment, the integration/monitoring dashboard further comprises a sub-tool including Gen AI quality metrics monitoring and a Gen AI infrastructure monitoring dashboard. In an embodiment, the integrations dashboard shows the functionality of the system (102). In an embodiment, the dashboard is the custom dashboard, configured for both functional observability and infrastructure monitoring of the AI and Gen AI application.

In an embodiment, the guardrails further comprises a plurality of sub tools including a Fender, defender, fender-IBM, fender Nemo, On-premise guard rail comparison, and Hyper-scalar guardrail comparison. The Guardrail tools may be used for detecting any adversarial and cyberattacks on the Gen AI applications.

In an embodiment, the Fender may classify content in both LLM inputs and responses, indicating whether they are safe or unsafe. The model uses a threshold to make binary decisions based on the probability scores. The text also outlines a taxonomy of harms and risk guidelines for automated content risk mitigation, providing examples of harmful content under different categories such as Violence & Hate, Sexual Content, Guns & Illegal Weapons, Regulated or Controlled Substances, Suicide and Self Harm, and Criminal Planning. The taxonomy is released as an open resource for the community.

In an embodiment, the system's task is to identify the prompt attacks by LLM-powered applications, which are attacks designed to subvert the intended behavior of language model models (LLMs). The Prompt attacks include prompt injection, which exploits untrusted data to manipulate the model's behavior, and jailbreaking, which involves overriding the model's safety and security features with malicious instructions. In an embodiment, the Defender is a classifier model trained to detect both explicitly malicious prompts and injected inputs.

In an embodiment, the Fender-IBM can classify content in both LLM inputs and responses, indicating whether they are safe or unsafe. The text also outlines a taxonomy of harms and risk guidelines for automated content risk mitigation, providing examples of harmful content under different categories such as Violence & Hate, Sexual Content, Guns & Illegal Weapons, Regulated or Controlled Substances, Suicide and Self-Harm, and Criminal Planning. The taxonomy is released as an open resource for the community.

In an embodiment, the Fender-Nemo may classify content in both LLM inputs and responses, indicating whether they are safe or unsafe. The model uses a config-based safety moderation. The config is deployed and customizable based on the user requirements. After the changes in config, it needs to be redeployed again. The model understands the below categories as hazardous and stops them from proceeding further. Below are a list of categories such as Violence, Hate, Sexual Content, Guns, Illegal Weapons, Regulated or Controlled Substances, Suicide, Self-Harm, Insult, Public Safety, Illicit Drugs, Religion & Belief, Science& Technology, War, Politics and Criminal Planning. The taxonomy is released as an open resource for the community.

The plurality of tools are ready-to-use capabilities that can be applied to a scenario. As per one example, for generating synthetic data for RAG Applications, the system (102) may use the automated RAG evaluation tool to perform load testing.

The plurality of tools such as the RAG Evaluation and Load Testing tools, are integrated with the core metric API's (304) through standard programmatic methods. Specifically, these tools invoke the necessary system's metrics using either cURL commands or Python's requests library. This allows them to programmatically access and utilize the metrics within their respective workflows.

In an embodiment, plurality of the tools (310) and THE plurality of API's (304) of the system (102) work in the same fashion. The tools (310) have extra functionality such that, the tool takes input (document or text) from a UI screen and shows the output on UI screen. The input may vary depending from metric to metric. The input is calculated and a score is given. For example, Bias Score, Hallucination score, etc. This scoring mechanism is based on open-source libraries like deep eval, deep check. Finally, the output is shown on UI screen. In an embodiment, the output may be in the form a JSON file.

The tools (310) combine multiple API's (304) for processing so there is a level of automation. The plurality of tool work on the simple strategy of 4 steps:
Step 1: Upload the data/documents
Step 2: Set the configuration. These configurations vary from tool to tool
Step 3: Begin Execution
Step 4: Evaluate the results

In an embodiment, the playbooks (308) are developed to help users to explain the steps for testing the Gen AI Applications. The playbooks (308) show each and every stepwise working to use the proposed system (102). In an embodiment, the playbooks (308) may be referred to as the guidebooks. These playbooks (308) include in-depth information such as the failure points, the pre-requisites, what to test, how to test, issues in testing, and any need of human intervention. In an embodiment, the system's library comprises a plurality of playbooks (308), including a RAG Validation playbook, a Non-Functional Validation playbook, an Agentic AI Validation playbook, Security validation, QnA Chatbot Validation, and Vision AI validation will be developed as per the roadmap.

The Playbooks (308) serve as a foundational guide for validating inputs throughout a generative AI system (102). The playbooks (308) are primarily designed to educate users on typical tests, testing methodologies, common challenges encountered during testing, and provide guidance on appropriate metric usage. Playbooks (308) help users to understand the landscape of testing and metric selection, but the provided information does not specify how they are technically linked or integrated with the API's (304) during execution. The focus is on providing knowledge and best practices rather than a direct programmatic connection.

In an embodiment, the Demo module (312) is used to demonstrate the visual representation of the working of any type of component in the real world by inputting the text or document of the respective component. The users may enter their text or documents in the system's prompt to see their real visual representation. In an embodiment, the demo module (312) may be referred to as a demo application. In an embodiment, the system (102) comprises a plurality of demo modules (312), including an Insurance Chatbot app, Banking Assessment Chatbot app, and News Analysis app. The system (102) also developed an application for the European Union Artificial Intelligence (EU AI) Act Validation.

In an embodiment, the playground Applications (316) are configured to test and evaluate to experiment with various testing tools (310) and methodologies. In an embodiment, the playground application (316) comprises Swagger API's, validation playground, guardrail experimentation, and prompt testing. As per one example, for validation Playground, the users may enter their data and test various quality metrics without explicitly writing code for it. As per another example, for Prompt Testing, the users may evaluate various prompting techniques. The users may select the appropriate system's metrics based on their needs. Users can leverage the playgrounds as a starting point to understand which metrics might be suitable for the customer use case.

In an embodiment, the assets (314) are an interface that acts like a library/collection of key artefacts such as golden datasets. Users can curate such assets (314) for collection and later reference. In an embodiment, the user may use the saved assets (314) for future use.

In an embodiment, the system (102) uses the database (306) in the backend to store various types of information. All information, such as metrics data, prompt library data, is saved in the database (306).

Development integration and production integration of the system is illustrated further. The APIs are designed to help test the GEN AI application in development and then take it to production. During development/testing, the APIs are integrated in the source code. The API may have a parameter “Reporting”, which is by default set to False. Before put the entire code into production, the Reporting parameter has to be set to True, this enables real-time monitoring of the GEN AI Applications in the production

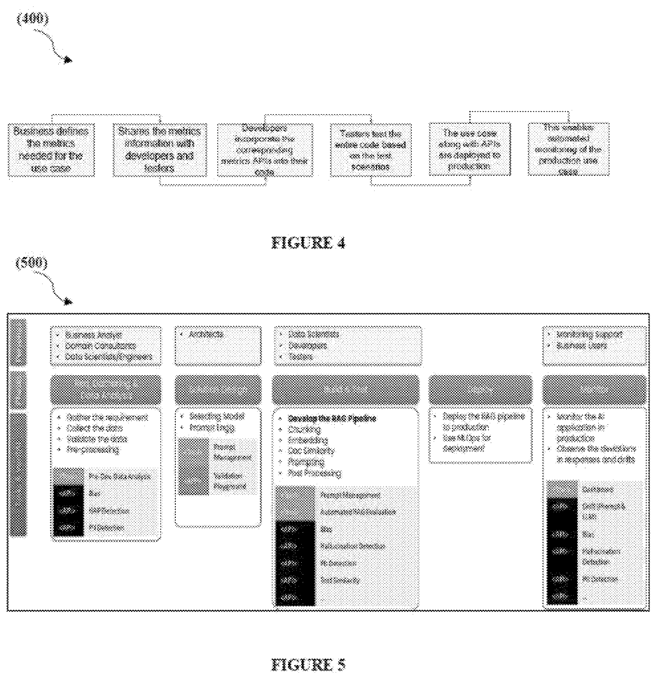

FIG. 4 illustrates a flow diagram showing the selection of API, in accordance with an embodiment of the present subject matter. The user may select the API's (304). The selection of API's (304) may depend on the business/regulatory requirement and as per the evaluation of users Gen AI application. Once API's (304) selected, these API's (304) will be part of the system (102), which will then automatically run when the use case is running in production. The process starts with business users or GEN AI application owner defining the quality metrics that want to measure and monitor. These are then passed on to the developer so as to include them in the code. Developers does so by including the corresponding metrics APIs that business has defined. The Gen AI application code is then tested by the testers for those quality metrics. Once the code is successfully tested, the GenAI application code (along with APIs may became the part of the application code) are deployed to production. Once there are deployed to production and when users start using the application, all the interaction will be measured, stored in the database and displayed on the dashboard for real time monitoring

FIG. 5 illustrates a block diagram showing the plurality of phases of the system (102) to test the development life cycles of AI and Gen AI applications. The system (102) is providing all kinds of solutions that can be applied across the entire process of the GEN AI use case development life cycle. The system (102) provides every type of testing, demo, and validation process that are involved in the development life cycle and testing phase of AI and Gen AI applications. In an embodiment, the several phases of the application need to be tested before launching the application into the market. The system (102) comprises a plurality of phases. The AI and Gen AI application experience all phases which are listed below:

Phase 1: Requirement Gathering and Data Analysis Phase: The users involved in this phase 1 are Business Analysts, Domain Consultants, and Data Scientists/engineers. These users may perform activities such as data analytics and engineering activities, such as gathering the data, validating the quality of data, and performing any pre-processing related to the application. Users may use the system's tools (310) (such as Pre-Dev Data Analysis) and API's (304) (such as Bias, HAP) to help with their data quality check activities by reducing manual workload. The tools (310) or API's (304) receive the data provided by the user, and the system (102) will generate output based on the selected quality metrics. Based on the output, the user may make or take a decision

Phase 2: System Design Phase: The user involved in phase 2 may be the Architects. The Architects may be typically design the prompts in this case. The system (102) provides different prompting techniques such as CoT, zero/few/one-shot examples, and variable. As per one example, the Architects may select the Prompt Management tool and the Validation playground (316) to carry out testing before making any design decision relating to the tested application. The Architects may save these prompts into the Prompt Management library. The Architect may also pass the prompt to the developers (320) to use it in their code.

The Prompt Management tool is a tool to build and test the prompts by using various techniques. Once the prompt is finalized, the system (102) may store the finalized in the prompt library. The developers (320) may copy and paste the stored prompts into their development code. In the future, an API may be created on the Prompt Management tool, which will allow automated fetching of these prompts into various tools (310) and use cases.

Phase 3: Build and Test Phase: The user involved in this phase may be Developers (320) and Testers. The developer and the tester may be doing the actual use case development and testing of the target application. The developers (320) and testers may leverage various API's (304) and Tools (310) (depending on their use case). The developer use this API and tools (310) for development and testers for testing the target application functionality. As per one example, the tester and developer may use tools (310) such as Automated RAG Evaluation or API's (304) such as PII detection, Hallucination, etc., to test the target application functionality. The tools (310) and API's (304) then provide the scoring and explanations. The developers (320) and testers may decide whether the test evaluation and validation pass or fail, according to the scoring and explanation provided by the tools (310) and API's (304). The developers (320) and tools (310) may use a plurality of API's (304) and stitch them together into a test automation script to automate the testing needs.

Phase 4: Deployment Phase

Phase 5: Monitoring Phase: The users involved in this phase are support teams and business users. In the monitoring phase, the support teams and business users may monitor how the inputted Gen AI applications are performing. The monitoring phase has various monitoring dashboards. The user may monitor for deviations in the configured parameters of inputted application. The monitoring phase may detect the anomaly in the inputted application. Accordingly, users may report to developers (320) and testers to relook into the Gen AI model when an anomaly is detected. The monitoring phase is a critical phase as it is necessary that the Gen AI application and model performance is sustained for a long term.

In an embodiment, the present disclosure provides a complete, end-to-end solution across the development life cycle, across different phases and different types of testing such as functional and non-functional testing of the application.

In an embodiment, the system (102) is based on open-source technologies, therefore, the system (102) is capable of supporting to any changes in the underlying functionality of the application. Accordingly, the system's underlying tools (310) are updated and developed.

In an embodiment, the system (102) is built on the micro-services architecture. The micro-services architecture allows for flexible and scalable validation processes. The architecture supports various types of integrations. The architecture builds innovative testing and evaluation tools (310). The architecture easily integrates with existing technology stacks and third-party solutions.

In an embodiment, the system (102) includes the plurality of API's (304), configured to allow users to create their own tools (310) and extend the capability to meet their business or regulatory requirements.

In an embodiment, the system (102) follows a plug-and-play architecture whereby any components or modules may be swapped with alternative components or modules to meet client requirements.

In an embodiment, the system (102) is based on contained technologies and deployed to any cloud service provider.

In an embodiment, the system (102) may be integrated with any LLMs (on-cloud such as Azure GPT, Bedrock, Google Gemini) or on-premises LLMs (such as Llama, IBM Granite).

In an embodiment, the system (102) is fully customizable based on customer needs, like changing the UI, adding/removing API's (304) and tools (310), adding new validation metrics, changing the underlying infrastructure and database (306), and creating a custom monitoring dashboard.

In an embodiment, the present disclosure provides the playbooks (308) to guide the users on how to perform testing.

In an embodiment, the system (102) is built on a 360-degree validation framework. The comprehensive approach covers all aspects of AI validation.

In an embodiment, the system (102) provides customizable validation metrics that allow users to define and adjust metrics based on specific project needs.

In an embodiment, the system (102) seamlessly integrates API's (304) that allow access for third-party solutions for enhanced functionality.

In an embodiment, the templatized integration simplifies the incorporation of validation processes into delivery frameworks.

In an embodiment, the system (102) assesses/validate the quality of data before it is used for AI model training.

In an embodiment, the system (102) evaluates AI models during development to ensure that the AI model meets accuracy and performance standards.

In an embodiment, the system (102) continuously monitors and tunes deployed models to maintain performance and reliability.

Technical solutions provided by the proposed system (102) are listed below:

Improved Data Quality: The system (102) ensures that only high-quality data is used for AI model training by validating data quality in the discovery and pre-development stages.

Consistent Outputs: In the production and post-production stages, the system verifies and tunes deployed models to ensure that outputs are consistent, explainable, and meet user expectations.

Faster AI Deployment: The comprehensive framework and pre-built solutions enable enterprises to scale their AI initiatives quickly and responsibly.

Reduced Risk: By automating the validation and verification processes, the system reduces the risk of errors and biases in AI models.

Exemplary embodiments discussed above may provide certain advantages. Though not required to practice aspects of the disclosure, these advantages may include those provided by the following features.

Comprehensive Coverage: The system offers a 360-degree validation framework that covers the entire AI lifecycle of application, from data validation to post-deployment tuning.

Customizable Metrics: The system allows users to define and adjust validation metrics based on specific project needs.

Microservices-based Architecture: The system facilitates easy integration with existing systems and scalability.

Seamless Integration: The system connects with various tools (310) and platforms to provide a seamless validation experience.

Industry Expertise: The system leverages extensive experience in AI validation and verification.

In some embodiment, the system addresses various regulatory requirements such as EU AI Act, US AI Bill of Rights and like more.

In some embodiment, the system addresses Responsible AI and AI Governance. The fundamental requirements of a Responsible AI system and of governance is that the AI system should be explainable, should be fair, transparent, there is accountability and human in the loop to review the outcomes as well as data protection and privacy are of utmost importance. This system ensures that these issues are addressed thereby helping with the Responsible AI and Governance requirements

In some embodiment, the system may test the AI application across its life cycle, right during pre-development, during development, and post-development.

In some embodiment, the system tests the AI applications for performance and scalability.

In some embodiment, the system may simulate cybersecurity and adversarial attacks on AI applications and prevent the attack.

In some embodiment, the system monitors AI applications in production and detects anomalous behaviour and takes timely action.

In some embodiment, the system may validate the data quality of the foundation data to avoid any sensitive information and maintain the foundation data to be accurate, complete, and free from biases.

In some embodiment, the system may test and detect PII or any other sensitive data getting leaked.

In some embodiment, the system tests whether the AI model is not hallucinating and not generating unwanted information such as inaccuracy, biasness, inconsistency, profanity, hatefulness, abusiveness, violence, sexuality, toxicity, etc.

In some embodiment, the system may test AI applications such as RAG AI Application, Agentic AI application, Summarization AI application, Generation AI, and Chatbot AI applications.

In some embodiment, the system may also generate a large volume of data for testing the AI application.

In some embodiment, the present disclosure provide a single system for various testing phases and applications.

In some embodiment, the system is used across the lifecycle of the Gen AI application. The system is used for Data Discovery and Data Engineering primarily by business analysts and domain consultants. The system may be used by developers (320) during the development cycle and by the support and business users once it goes into production.

In an embodiment, every developed GenAI application may undergo through testing before it is released to production and also requires observability of sustenance. The proposed system is used to test any kind of application. Some of the examples are:

AI-driven financial services: The system ensures the accuracy and reliability of AI models used in financial forecasting and fraud detection.

Healthcare diagnostics and treatment planning: The system is validating AI models which used for diagnosing diseases and planning treatments.

Retail and consumer behaviour analysis: The system ensures the accuracy of AI models used for predicting consumer behaviour and optimizing inventory.

Manufacturing process optimization: The system is validating AI models, which are further used for improving manufacturing processes and reducing defects.

Personalized marketing and advertising: The system ensures the accuracy of AI models, which are used for targeting advertisements and personalizing marketing campaigns.

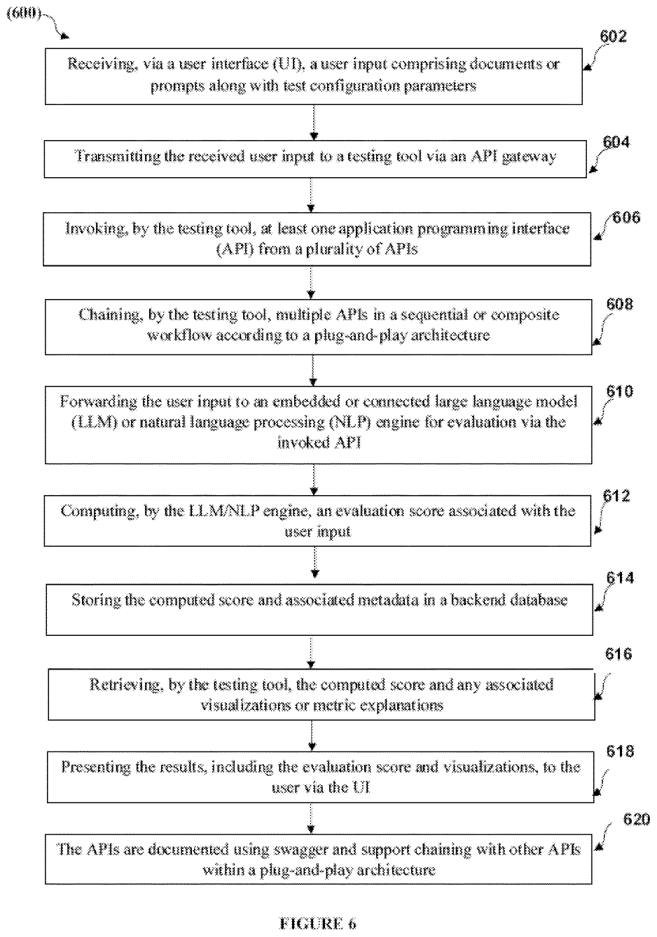

FIG. 6 illustrates a flow chart performing a method (600) for testing and validating an artificial intelligence (AI) and generative AI application, in accordance with an embodiment of the present subject matter. The order in which the method (600) may be described may be not intended to be construed as a limitation, and any number of the described method blocks may be combined in any order to implement the method (600) or alternate methods. Additionally, individual blocks may be deleted from the method (600) without departing from the spirit and scope of the subject matter described herein. Furthermore, the method (600) may be implemented in any suitable hardware, software, firmware, or combination thereof. However, for ease of explanation, in the embodiments described below, the method (600) may be considered to be implemented as described in the system (102) for a testing the artificial intelligence (AI) and generative AI application.

At block 602, the system (102) is receiving, via a user interface (UI) (302), a user input comprising documents or prompts along with test configuration parameters.

At block 604, the system (102) is transmitting the received user input to a testing tool (310) via an API gateway.

At block 606, the system (102) is invoking, by the testing tool (310), at least one application programming interface (API) (304) from a plurality of APIs (304), by issuing a structured request to an endpoint URL via the API gateway.

At block 608, the system (102) is chaining, by the testing tool (310), multiple APIs (304) in a sequential or composite workflow according to a plug-and-play architecture, wherein the output of one API (304) is used as input or context for another.

At block 610, the system (102) is forwarding the user input to an embedded or connected large language model (LLM) or natural language processing (NLP) engine for evaluation via the invoked API (304).

At block 612, the system (102) is computing, by the LLM/NLP engine, an evaluation score associated with the user input, including but not limited to bias, correctness, groundedness, or security metrics.

At block 614, the system (102) is storing the computed score and associated metadata in a backend database (306).

At block 616, the system (102) is retrieving, by the testing tool (310), the computed score and any associated visualizations or metric explanations.

At block 618, the system (102) is presenting the results, including the evaluation score and visualizations, to the user via the UI (302).

At block 620, the APIs (304) are documented using swagger and support chaining with other APIs within a plug-and-play architecture.

### EQUIVALENTS

With respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

Although implementations for the system and method for testing an artificial intelligence (AI) and generative AI application have been described in language specific to structural features and/or methods, it is to be understood that the appended claims are not necessarily limited to the specific features described. Rather, the specific features are disclosed as examples of implementation for the system and method for testing an artificial intelligence (AI) and generative AI application.

We claim:

1. A system (102) for testing an artificial intelligence (AI) and generative AI applications, the system (102) comprising:
a user interface (UI) (302) configured to enable user interaction and facilitate access to a plurality of application programming interfaces (APIs) (304), and a set of testing tools (310), wherein the UI (302) is operatively coupled to a processor and a memory, and wherein the processor is configured to:
receive a user input data, comprising documents or prompts, via the UI (302);
transmit the input data via an API gateway to at least a testing tool (310), wherein each tool from the set of tools (310) communicatively coupled with the APIs (304), executable via the user interface (302), wherein the tools (310) are configured to:
chain multiple APIs together and invoke at least an API from plurality of APIs (304) using an endpoint URL on the basis of said input and transmit the user input data to the invoked API (304) via the API gateway;
wherein the invoked API (304) is configured to forward the user input data to an embedded or connected LLM/NLP engine for evaluation, receive and compute an evaluation score corresponding to said data;
store the computed score in the backend database (306) and return the score to the testing tool (310) so as to visualize said score; and
present the computed score, visualizations, and metric explanations to the user via the UI (302); and
wherein the APIs (304) are documented using swagger and support chaining with other APIs within a plug-and-play architecture.

2. The system (102) as claimed in claim 1, wherein the plurality of APIs (304) comprises:
a) one or more governance APIs selected from the group comprising of:
a hallucination detection API configured to flag AI-generated content not grounded in source data, a bias and fairness evaluation API configured to detect algorithmic bias across demographic parameters, a personally identifiable information (PII) detection API configured to identify and redact sensitive data, a high assurance processing (HAP) detection API, a prompt drift detection API, and a large language model (LLM) drift detection API;
(b) one or more functional APIs selected from the group comprising of:
chunk relevance, groundedness, response relevance, correctness, BLEU, ROUGE, METEOR, BERTScore, sentence mover similarity, and completeness;
(c) one or more non-functional APIs selected from the group comprising of:
token count, throughput, latency, robustness, toxicity, social harm, and model drift;
(d) one or more security APIs selected from the group comprising of:
prompt injection detection, data poisoning detection, sensitive output handling, and custom security prompt design.

3. The system (102) as claimed in claim 1, wherein the APIs (304) are implemented as independent micro services, each accessible at an endpoint URL, deployed on containers managed via container orchestration platforms including Docker or Kubernetes.

4. The system (102) as claimed in claim 1, wherein each API (304) is documented and accessible through a Swagger interface, and programmatically callable via common scripting interfaces including Python's requests library or cURL.

5. The system (102) as claimed in claim 1, comprising an LLM-based scoring module integrated within the APIs (304), configured to:
extract claims from AI-generated responses, compare the claims with retrieved contextual data, generate a hallucination score using binary judgments, and output both metric scores and natural language justifications.

6. The system (102) as claimed in claim 1, wherein the tools (310) are configured to perform tasks comprising:
(a) test-driven RAG development, comprising automated RAG evaluation, chunking, embedding, and vector database selection; (b) multi-agent system simulation with agentic scoring and tool selection; (c) non-functional load and stress testing with visualized metrics; (d) adversarial and prompt injection testing using security utilities; and (e) visualization and real-time monitoring via dashboards.

7. The system (102) as claimed in claim 1, wherein the plug-and-play architecture enables chaining of APIs (304) into user-defined workflows, orchestrated using a code integration application (320).

8. The system (102) as claimed in claim 1, comprising a reference playbooks (308) provide step-by-step procedures for validating generative AI applications, stored in the backend database (306) and accessible via the user interface (302).

9. The system (102) as claimed in claim 1, comprising a demo module (312) configured to simulate real-world AI use cases including chatbot testing, insurance processing, and news summarization, using uploaded user data.

10. The system (102) as claimed in claim 1, comprising a playgrounds (316) module configured to provide interactive, code-free testing environments that utilize embedded Swagger APIs for prompt testing, security guardrail evaluation, and output validation.

11. The system (102) as claimed in claim 1, wherein the testing tools (310) comprise a workflow orchestration engine configured to select, arrange, and execute a sequence of APIs (304) based on a user-defined test plan.

12. The system (102) as claimed in claim 1, wherein the plug-and-play architecture enables addition, removal, or reordering of APIs (304) in a validation workflow without requiring code changes to the core system and wherein the processing unit (202) is configured to orchestrate a plurality of metric API's (304) in a plug-and-play architecture using programmatic methods for use case-specific validation workflows.

13. The system (102) as claimed in claim 1, wherein the evaluation scores are generated by the large language model (LLM) using a prompt-based evaluation steps and a QAG (Quality Assurance Group) scorer.

14. The system (102) as claimed in claim 1, wherein the APIs (304), when invoked via the testing tools (310), are configured to evaluate AI and GenAI outputs for one or more quality and risk parameters comprising hallucination, bias, relevance, groundedness, correctness, latency, security vulnerabilities, and compliance, and to return corresponding evaluation scores or annotations that are stored in the backend database (306) and rendered to the user interface (302) or a monitoring dashboard for interpretation and analysis.

15. A method (600) for testing and validating Artificial Intelligence (AI) and Generative AI (GenAI) applications using a system (102), the method comprising:
receiving, via a user interface (UI) (302), a user input comprising documents or prompts along with test configuration parameters;
transmitting the received user input to a testing tool (310) via an API gateway;
invoking, by the testing tool (310), at least one application programming interface (API) (304) from a plurality of APIs (304), by issuing a structured request to an endpoint URL via the API gateway;
chaining, by the testing tool (310), multiple APIs (304) in a sequential or composite workflow according to a plug-and-play architecture, wherein the output of one API (304) is used as input or context for another;
forwarding the user input to an embedded or connected large language model (LLM) or natural language processing (NLP) engine for evaluation via the invoked API (304);
computing, by the LLM/NLP engine, an evaluation score associated with the user input, including but not limited to bias, correctness, groundedness, or security metrics;
storing the computed score and associated metadata in a backend database (306);
retrieving, by the testing tool (310), the computed score and any associated visualizations or metric explanations;
presenting the results, including the evaluation score and visualizations, to the user via the UI (302); and
wherein the APIs (304) are documented using swagger and support chaining with other APIs within a plug-and-play architecture.
